(19) United States
(12) Patent Application Publication
(10) Pub. No.: US 2017/0086434 A1
(43) Pub. Date: Mar. 30, 2017

(54) Clip-on attractor to fishing lures

(71) Applicant: Robert A. Locker, Bozeman, MT (US)

(72) Inventor: Robert A. Locker, Bozeman, MT (US)

(21) Appl. No.: 14/863,566

(22) Filed: Sep. 24, 2015

(51) Int. Cl. A01K 85/10; A01K 85/12

(52) U.S. Cl. CPC A01K 85/10; A01K 85/12

(57) ABSTRACT

A clip-on attactor for fishing lures, hooks, fly's, etc. which can be easily connected or removed, but is resistant to loss from the action of a fish striking the lure, or the ensuing struggle. A V-grooved entry point,or notch opens to a connecting hole. The various shaped attractors can be quickly clipped on the front, middle, or rear split rings on standard lures and also (using the smaller V-groove and connection hole so it will not slip over the barb) clipped on the bend of the hook for uses such as bait hooks and flies.

### FIELD OF THE INVENTION

The present invention relates to fishing lures and, more particularly to a clip-on attractor for artificial lures, hooks and flys.

### BACKGROUND OF THE INVENTION

Fishing lures bear a strong resemblance to women and to the length girls go to make themselves attractive. It starts with a closet full of clothes, from cocktail dresses and evening gowns, to pants suits and blue jeans, and a wide assortments of footwear. Lots of time, money and effort goes into that effort.

However, women don't stop there. They usually have a far larger number of items designed to enhance that appeal. This ranges from lip stick and eye shadow, to earrings, necklaces and bracelets, hair colorings and styling's, and yes let's not forget perfume. In some cases the cost and variety of these items exceeds the cost of the wardrobe.

Fishing lures are much like a wardrobe, without any help from enhancements. It is not so much the size, shape, color and action of the lures, but what they do not have.

It is surprising how limited the concept of added attractors has been. Some lure manufactures have added an enticement to the rear split ring such as the tear drop often sold with the “Swedish Pimple” by Bay de-noc Lure Company, an ice fishing standard.

Many manufacturers have added bucktail or Mylar to the hooks (a form of added embellishment) of various types of lures from spinners, to spoons and plugs. One example would be Warden's “Roostertail” spinner. They most commonly are sold with the various colors of bucktail added to a treble hook.

Flies for fly fishing take on a nearly infinite variety of shapes, colors, and materials in intricate attempts to emulate insects in various stages of their life cycle, as well as mimic bait fish.

Almost all of the existing attractors are packaged with the lure or already attached. Most anglers are forced to buy the entire lure because the bucktail or the teardrop might enhance the lures chances of success and very often it will.

To change these enhancements usually requires the addition or removal of the item from a split ring, and that often means using a special tool called a split ring pliers. Rarely do angler's carry one, much less a number of different split ring pliers to effectively accommodate various sizes of split rings.

Furthermore very few (if any) attractors are sold separately, and even in the case of hooks with bucktail that can be purchased they are rarely available in the sporting goods stores and must be ordered separately and added by the angler.

The fly fishing industry had gone to great lengths to emulate various insects and minnows but no article can simply clip on the bend of the hook. This is also true in jig fishing and bait as well as ice fishing, although it is a very common practice to add a small section of actual worm or grubs etc. to the hook.

The ability to quickly change various attractors for the many forms of lures, including plugs, spinners, spoons, flies, jigs and baited hooks has simply been missing.

### SUMMARY OF THE INVENTION

In accordance with the present invention, there is provided a clip-on attractor to fishing lures, hooks, etc. which, due to a V groove, can be easily clipped to a variety of connection points, but is resistant to loss due to the action of a fish striking or the ensuing struggle.

It would be advantageous to provide an attractor which can be added or removed from a fishing lure with a minimum of time and effort.

It would also be advantageous to allow quick connection to a split ring in the front, middle or rear of a fishing lure.

It would also be advantageous to clip to the bend of a hook or fly so that the attractor can be close to the barb of the hook, but with a smaller connection hole that will not slip over the barb.

It would be further advantageous to provide a clip on attachment that can be stored in a container or sprayed with various scents to further entice fish through their sense of smell.

Is also advantageous to provide a wide range of sizes to accommodate fishing lures from small flies and panfish lures, to large deep water tuna and rockfish jigs.

It is further an object of this invention to provide different shaped attractors, most common of which are, the tear drop shape, a minnow like split tail, crescent shaped single tail, and a grub shaped tail. This is not limited to the 4 shapes described, but merely shows some of the possibilities

### BRIEF DESCRIPTION OF THE DRAWINGS

A complete understanding of the present invention may be obtained by reference to the accompanying drawings, when considered in conjunction with the subsequent, detailed description, in which:

FIG. 1 is a plan view of a teardrop shaped attractor with a side v-groove entrance to the connecting hole for attachment to split rings etc;

FIG. 2 is a plan view of an illustrating a smaller connection hole and v-groove slot for clipping to the bend portion of a plain hook. jig, or fly;

FIG. 3 is a plan view of a cresent shaped fish tail attractor;

FIG. 4 is a plan view of a split tail shaped attractor;

FIG. 5 is a plan view of a grub or worm shaped attractor; and

FIG. 6 is a plan view of a sample placements of various shapes of clip on attractors.

For purposes of clarity and brevity, like elements and components will bear the same designations and numbering throughout the Figures.

### DESCRIPTION OF THE PREFERRED EMBODIMENT

Although the heart of this invention is the manner in which the attractor can be attached or removed from various fishing lures, it also uses the clip-on feature to illustrate various shapes of attractors that will be used.

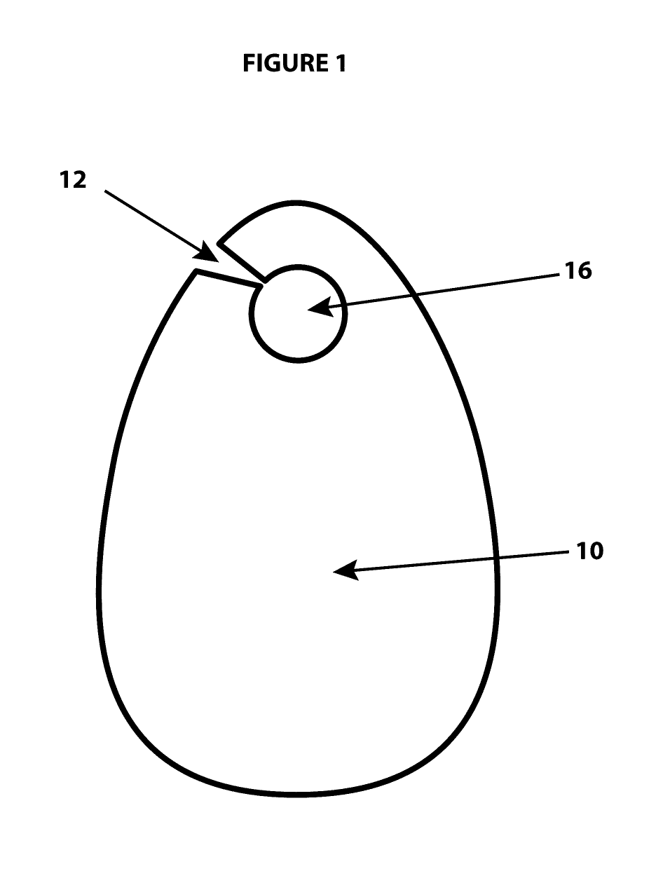

FIG. 1 is a plan view of a tear drop shaped attractor 10 with V-groove notch 12 to the connecting hole 16 for attachment to split rings, etc. Not shown, the attractor can be made from metal, plastic or other composite material, and can be flexible including the V-groove notch 12.

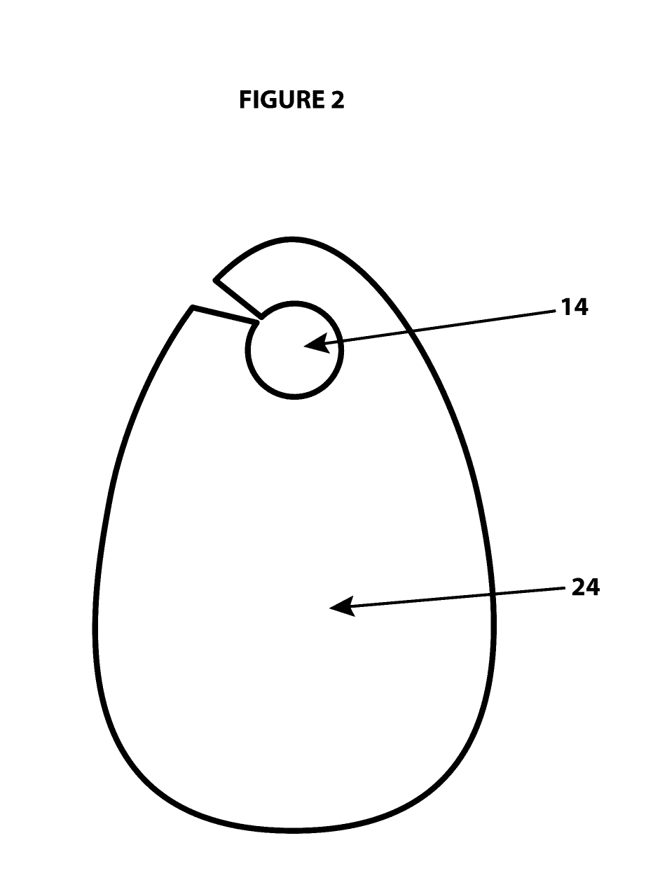

FIG. 2 is a plan view of a tear drop shaped attractor 10 illustrating a smaller connecting hole 16 and V-groove notch 12 for clipping to the shank of a hook or fly, not shown.

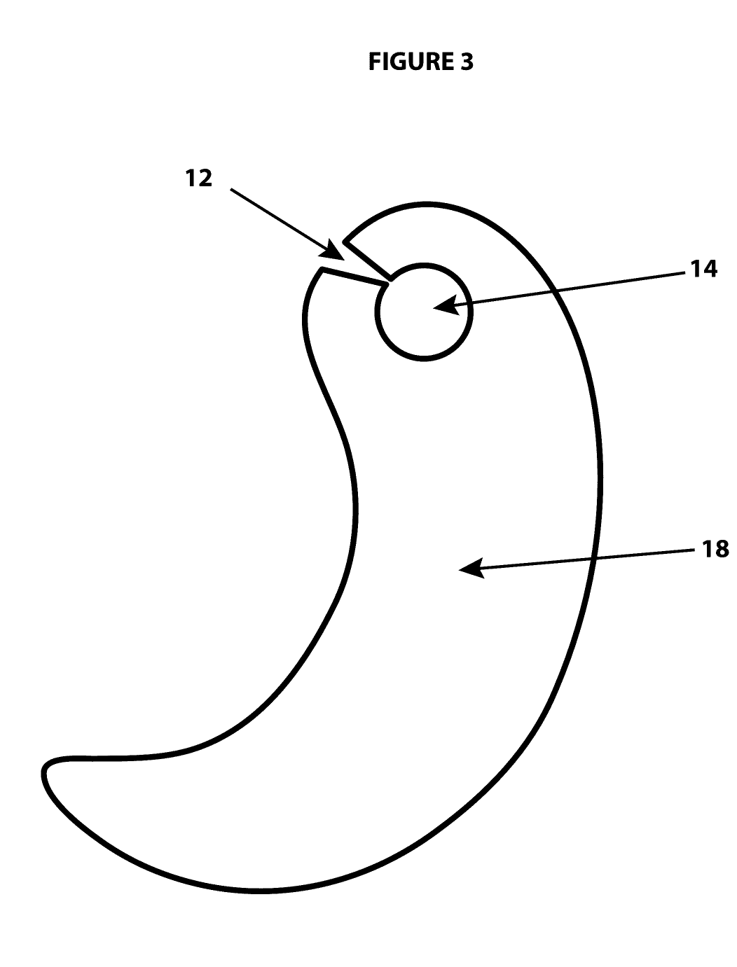

FIG. 3 is a plan view of a crescent shaped attractor 18 using the same two sizes of V-groove notch 12, as shown in FIGS. 1 and 2. The crescent shape is particularly effective because it moves dramatically when a lure or fly is twitched or manipulated. Also when moved forward the shape dictates that the crescent shaped attractor 18 will move from side to side by the force of the water resistance. It should be noted that all of the various shapes of attractors can be made of different materials, some of which are pervious and allow for the penetration of various scents. The material will hold some scent and release a small amount of this scent for a protracted period of time.

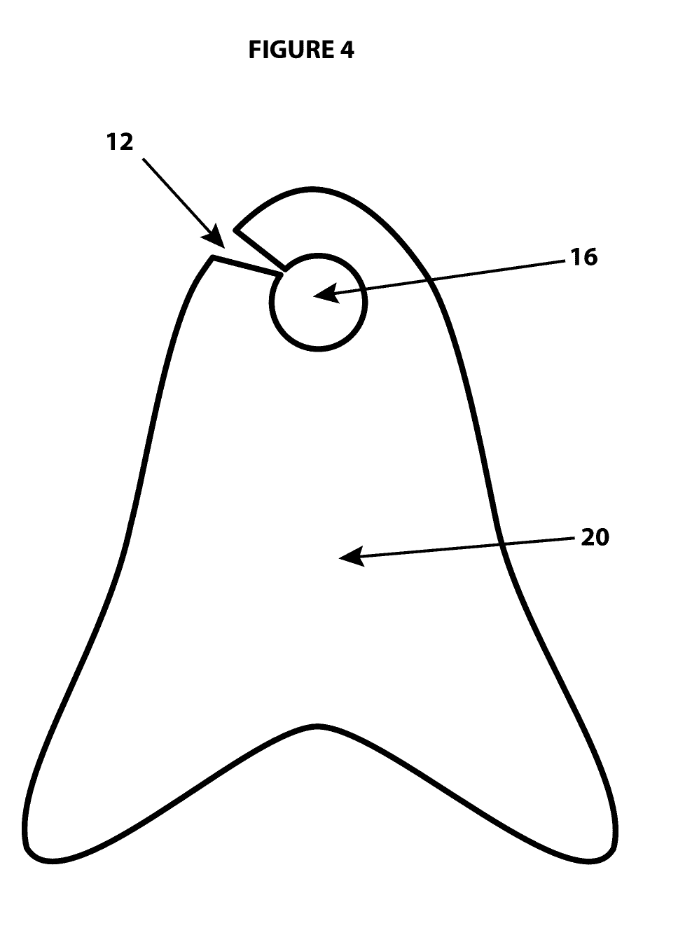

FIG. 4 is also a plan view showing the split tail shaped attractor 20 resembling the tail of a minnow or other bait fish. This is particularly appealing when used with lures or flies designed to imitate a bait fish, as the tail is the first thing to move when the bait fish is beginning to change locations or attempt to escape. Since the connecting hole 16 is larger in diameter than the split ring or hook bend, not shown, to which it is attached, it allows for tantalizing movement even when the lure itself is almost stationary.

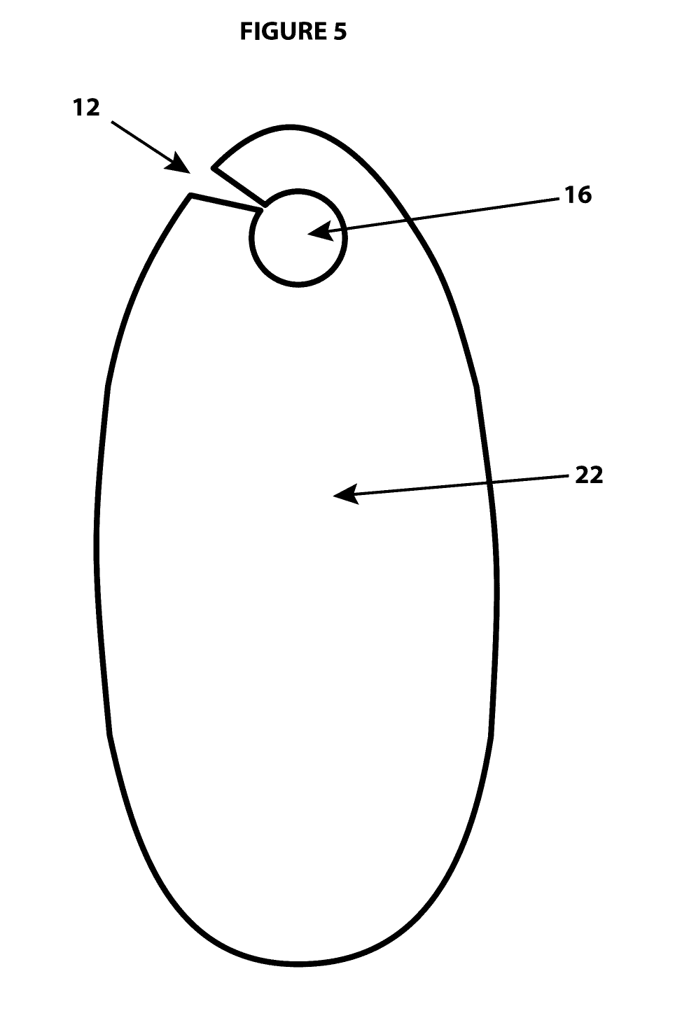

FIG. 5 is yet another attractor form, the grub shaped attractor 22, which is commonly seen by fish since it resembles the larva stage of many common aquatic (and non-aquatic) insects prevalent in the diet of common fresh water fish. It further resembles a section of a night crawler or earth worm and in a pervious form can hold the scent of the species it is emulating.

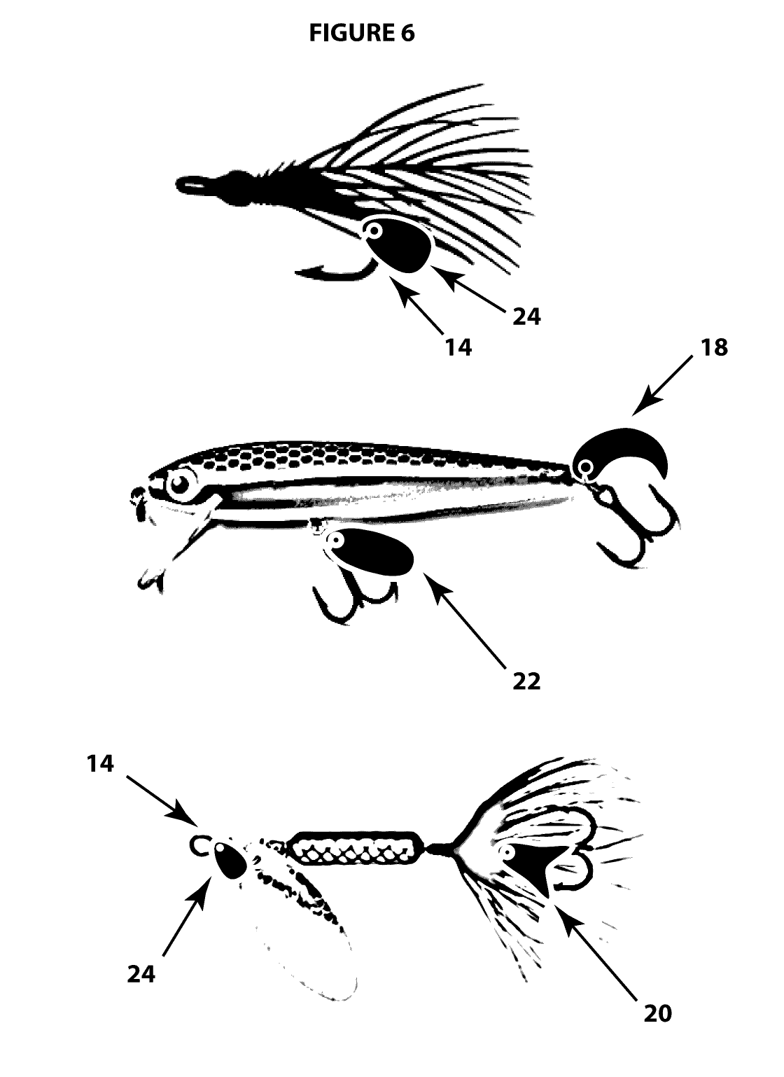

FIG. 6 is an illustration of uses for various lures and locations on those lures where the attractor 20, 22, 24 can be applied, particularly, the shank or bend of a hook. This a much overlooked area for placement since it puts the attractor very close to the barb or point of the hook. This could revolutionize the use of many sub-surface flies as it allows the angler to try different looks and scents without the need to replace the fly. Furthermore, the use of single and treble hooks are camouflaged by the addition of the attractor to the hook bend rather than the split ring. Often fish will key on the attractor rather than the entire lure which will increase the percentage of successful “hook ups”.

The top illustration is a streamer fly with a tear drop shaped attractor 10 place on the bend of the hook.

The middle illustration is a plug which often has two or three hooks attached by split rings to the lure body, thus giving several different opportunities to attach attractors. This plug shows a grub shaped attractor 22 on the middle split ring and a crescent shaped attractor 18 on the rear split ring.

The lower lure is a spinner with a tear drop shaped attractor 10 on the front wire ring and a split tail shaped attractor 20 on the rear split ring.

Keep in mind these are just examples of various common shapes for attractors but all varieties of shapes are claimed.

The material these various shapes are constructed can be of plastic, many of which can be pervious and allow various scents to be emitted. The plastics also can be made with a degree of flexibility which makes the attachment and particularly the removal less difficult, The V-groove notch 12 allows quick and efficient access to the connecting hole 16 but once inside, it is resistant to unintentional removal (as when a fish if hooked and attempting to escape). Yet the flexibility and memory characteristics allow the angler to remove the attractor by forcing the sides of the connecting hole 16 at the entry point to part slightly.

Another material can be metal, which has the advantage of a metallic sheen without the need for paint or other costly steps in the production of attractors. It also can be made of relatively thin material which can add to its seductive movement even when twitched ever so slightly, as in ice fishing or vertical jigging.

Suffice it to say this should have a very far reaching impact on all aspects of fishing and reduce the cost to the angler who longer will need to buy the entire lure, just to change the appeal.

So apply that lipstick, dab on the perfume, put on earrings and a bracelet, and let's go fishing!.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A clip-on attractor to fishing lures for facilitating the rapid addition or removal of an attractor to fishing lures, hooks, and flys, comprising:
means for <purpose>;
means for providing the containment point, rigidly connected to said means for <purpose>;
means for providing easy and rapid access to the connecting hole, rigidly connected to said means for providing the containment point;
means for provide hook bend attachment for bait hooks and flys;
means for resembling the tail of minnow, or leach;
means for resembling the look and action of a bait fish tail;
means for resembling the look of a grub, maggot, or partial earth worm or grub; and
means for clipping on to smaller diameter connections such as the bend of a fly or bait hook.

2. The clip-on attractor to fishing lures in accordance with claim 1, wherein said means for <purpose> comprises a new attribute 1, notch to the hole tear drop shaped attractor.

3. The clip-on attractor to fishing lures in accordance with claim 1, wherein said means for providing the containment point comprises a connecting hole.

4. The clip-on attractor to fishing lures in accordance with claim 1, wherein said means for providing easy and rapid access to the connecting hole comprises a v-groove notch.

5. The clip-on attractor to fishing lures in accordance with claim 1, wherein said means for provide hook bend attachment for bait hooks and flys comprises a smaller notch and hole.

6. The clip-on attractor to fishing lures in accordance with claim 1, wherein said means for resembling the tail of minnow, or leach comprises a crescent shaped attractor.

7. The clip-on attractor to fishing lures in accordance with claim 1, wherein said means for resembling the look and action of a bait fish tail comprises a split tail shaped attractor.

8. The clip-on attractor to fishing lures in accordance with claim 1, wherein said means for resembling the look of a grub, maggot, or partial earth worm or grub comprises a grub shaped attractor.

9. The clip-on attractor to fishing lures in accordance with claim 1, wherein said means for clipping on to smaller diameter connections such as the bend of a fly or bait hook comprises a small tear drop shaped attractor.

10. A clip-on attractor to fishing lures for facilitating the rapid addition or removal of an attractor to fishing lures, hooks, and flys, comprising:
a new attribute 1, notch to the hole tear drop shaped attractor, for <purpose>;
a connecting hole, for providing the containment point, rigidly connected to said tear drop shaped attractor;
a v-groove notch, for providing easy and rapid access to the connecting hole, rigidly connected to said connecting hole;
a smaller notch and hole, for provide hook bend attachment for bait hooks and flys;
a crescent shaped attractor, for resembling the tail of minnow, or leach;
a split tail shaped attractor, for resembling the look and action of a bait fish tail;
a grub shaped attractor, for resembling the look of a grub, maggot, or partial earth worm or grub; and
a small tear drop shaped attractor, for clipping on to smaller diameter connections such as the bend of a fly or bait hook.

11. A clip-on attractor to fishing lures for facilitating the rapid addition or removal of an attractor to fishing lures, hooks, and flys, comprising:
a new attribute 1, notch to the hole tear drop shaped attractor, for <purpose>;
a connecting hole, for providing the containment point, rigidly connected to said tear drop shaped attractor;
a v-groove notch, for providing easy and rapid access to the connecting hole, rigidly connected to said connecting hole;
a smaller notch and hole, for provide hook bend attachment for bait hooks and flys;
a crescent shaped attractor, for resembling the tail of minnow, or leach;
a split tail shaped attractor, for resembling the look and action of a bait fish tail;
a grub shaped attractor, for resembling the look of a grub, maggot, or partial earth worm or grub; and
a small tear drop shaped attractor, for clipping on to smaller diameter connections such as the bend of a fly or bait hook.
